(19) United States
(12) Patent Application Publication
(10) Pub. No.: US 2020/0314099 A1
(43) Pub. Date: Oct. 1, 2020

(54) INFORMATION PROCESSING APPARATUS AND NON-TRANSITORY COMPUTER READABLE MEDIUM STORING PROGRAM

(71) Applicant: FUJI XEROX CO., LTD., Tokyo (JP)

(72) Inventor: Rie NAKAZATO, Kanagawa (JP)

(73) Assignee: FUJI XEROX CO., LTD., Tokyo (JP)

(21) Appl. No.: 16/516,263

(22) Filed: Jul. 19, 2019

(30) Foreign Application Priority Data
Mar. 25, 2019 (JP) 2019-057365

(51) Int. Cl. H04L 29/06

(52) U.S. Cl. CPC H04L 63/0884; H04L 63/101; H04L 63/102; H04L 63/0815

(57) ABSTRACT

An information processing apparatus includes an attribute information acquisition unit that acquires attribute information associated with an account to other sites available for connection to a connection target site and a presentation unit that presents, to a user, attribute information that needs to be input in a case of using the accounts to the other sites for the connection to the connection target site before the connection to the connection target site is performed.

### CROSS-REFERENCE TO RELATED APPLICATIONS

This application is based on and claims priority under 35 USC 119 from Japanese Patent Application No. 2019-057365 filed Mar. 25, 2019.

### BACKGROUND

### (i) Technical Field

The present invention relates to an information processing apparatus and a non-transitory computer readable medium storing a program.

### (ii) Related Art

Authentication by an identity provider (IdP) maybe used for logging in to a website providing a service through a network. In JP2017-204196A, a service providing system including an IdP server that issues login information in a case where a user logs in and a service providing server that provides a service to the user based on the issued login information is disclosed. The service providing server includes an account management unit and an account storage unit that stores initial setting information applied first when the user uses the service based on login information, and the account management unit manages the issued login information and setting information for specifying the user in association with an account of the user and manages the issued login information and the initial setting information in association with each other.

In JP2011-165073A, a configuration, in which a web server that executes a web application and an IdP that stores attribute information of a user of a browser device used in a case of executing the web application are included, a message to be sent from the web server to the IdP is acquired in a case where the web server acquires the attribute information from the IdP, an acquisition destination of the attribute information in the web server is specified based on contents of the message and the specified acquisition destination is stored, and an evaluation value is calculated based on a use frequency as the acquisition destination of attribute information, which is a use frequency of stored attribute exchange history information, is disclosed.

### SUMMARY

In order to reduce the time and effort of a login operation, there is a mechanism for enabling use of an account for logging in to other sites to log in to a login target site. For example, it is a social login and the like which log in using an account of a social networking service (SNS) site. However, attribute information of the user needed for setting of an account of each site may be different, and additional input of information may be needed for login using an account of another site. Here, in a case where there are multiple other sites for which an account can be used, in a case where it is possible to know in advance what kind of information needs to be additionally input for a case of using an account of which site, it can be used as a reference for the user to select an account.

Aspects of non-limiting embodiments of the present disclosure relate to an information processing apparatus and a non-transitory computer readable medium storing a program that acquire information that requires additional input and notify the information according to an account to be selected in a system for enabling use of an account for logging in to other sites to log in to a login target site.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including an attribute information acquisition unit that acquires attribute information associated with accounts to other sites available for connection to a connection target site and a presentation unit that presents, to a user, attribute information that needs to be input in a case of using the accounts to the other sites for the connection to the connection target site before the connection to the connection target site is performed.

### BRIEF DESCRIPTION OF THE DRAWINGS

Exemplary embodiment(s) of the present invention will be described in detail based on the following figures, wherein:

FIG. 1 is a diagram illustrating an entire configuration of an information processing system to which the exemplary embodiment of the invention;

FIG. 2 is a diagram illustrating a functional configuration of a system server;

FIG. 3 is a diagram illustrating a functional configuration of a terminal device;

FIG. 4 is a flowchart illustrating an operation of the system server at the time of login to a connection target server;

FIG. 5 is a view illustrating an example of a configuration of a login screen;

FIG. 6 is a view illustrating a display example of attribute information items on the login screen;

FIG. 7 is a view illustrating another display example of attribute information items on the login screen;

FIG. 8 is a view illustrating a display example of attribute information items and usage policies on the login screen; and

FIG. 9 is a diagram illustrating a configuration of a relay server.

### DETAILED DESCRIPTION

Hereinafter, an exemplary embodiment of the present invention will be described in detail with reference to the accompanying drawings.

System Configuration

In the exemplary embodiment of the invention, a configuration in which one site to be connected (hereinafter referred to as a connection target site) is permitted to log in using an account for login to other sites (hereinafter referred to as linked sites) linked to the connection target site and the connection target site itself acquires and presents information on the account for login to the linked site will be described as an example.

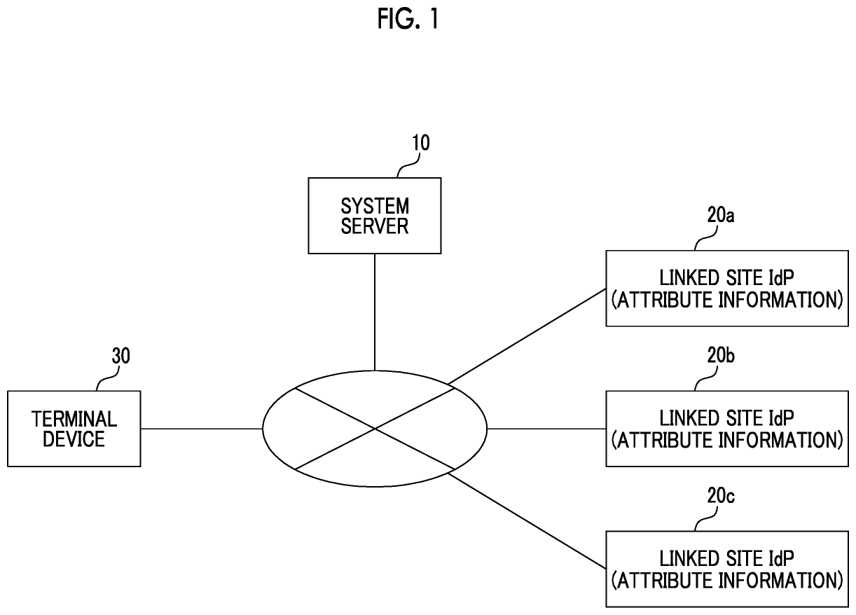

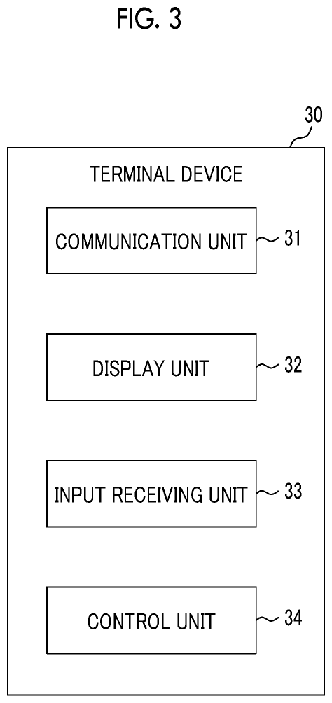

FIG. 1 is a diagram illustrating an entire configuration of an information processing system to which the exemplary embodiment of the invention. The information processing system of the exemplary embodiment includes a system server 10, linked sites IdPs 20a, 20b, and 20c, and a terminal device 30 that are connectable to each other through a network. In the information processing system illustrated in FIG. 1, the system server 10 configures a connection target site. The linked sites IdP 20a, 20b, and 20c are IdPs that manage an account for logging in to the linked site and attribute information associated with the account. In the example of illustration, three linked sites IdPs 20a, 20b, and 20c corresponding to three linked sites (not illustrated) are illustrated. The number of linked sites and their IdPs is not limited to three exemplified in FIG. 3. In the following description, in a case where individual linked sites IdPs 20a, 20b, and 20c are not distinguished from one another, suffixes a, b, and c are omitted and simply described as a linked site IdP 20. The terminal device 30 is an information terminal device for connecting to the connection target site. The network is, for example, the Internet.

In a system configuration illustrated in FIG. 1, the connection target site and the system server 10 are a site to which the user intends to connect from the terminal device 30 and a server that configure the site, does not indicate only a specific particular site and server. That is, the connection target site is a site that exists on the network and can be connected from the terminal device 30, and a target site to which the terminal device 30 has made a login request (login screen acquisition request) for connection is the connection target site. A server that configures the connection target site and has the following functional configuration having such a connection target site and having the following functional configuration is the system server 10.

Functional Configuration of System Server

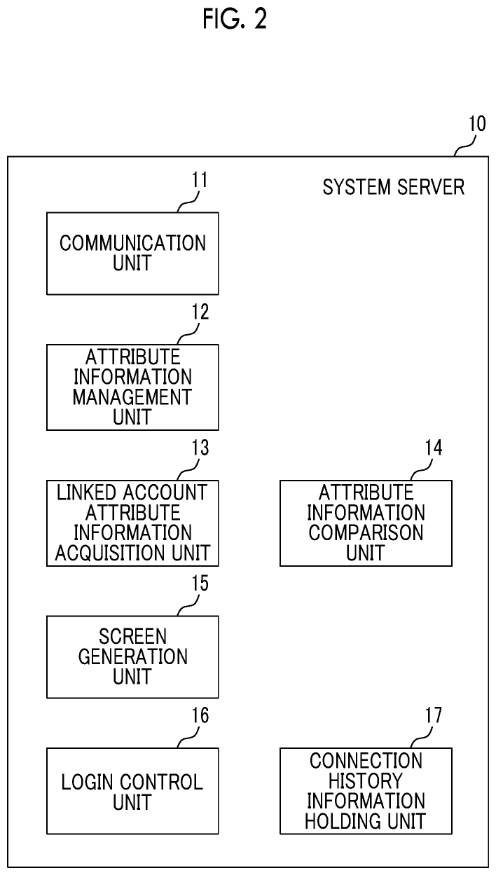

FIG. 2 is a diagram illustrating a functional configuration of a system server 10. The system server 10 includes a communication unit 11, an attribute information management unit 12, a linked account attribute information acquisition unit 13, an attribute information comparison unit 14, a screen generation unit 15, a login control unit 16, and a connection history information holding unit 17. The system server 10 configures one of the sites providing a service through a network. In FIG. 2, only the configuration relating to login control according to the exemplary embodiment of the invention is described, and a configuration relating to provision of the service is not described. Further, the system server 10 may be realized by a single server device, or may be realized by distributing functions to multiple servers connected through a network.

The communication unit 11 is a network interface for exchanging data with the linked site IdP 20 and the terminal device 30 through the network. Connection means of the network is not particularly limited, and the communication channel may be a wired communication channel or a wireless communication channel.

The attribute information management unit 12 manages an account for logging in to the connection target site which is the own site (hereinafter, referred to as an own site account) and attribute information associated with the registered own site account. The attribute information is information of a user whose registration is required to receive the service provided by the connection target site. That is, in order to use the service of the connection target site realized by the system server 10, it is necessary to input information corresponding to the attribute information managed by the attribute information management unit 12.

The linked account attribute information acquisition unit 13 acquires an item of attribute information associated with an account site (hereinafter, referred to as a linked account) for logging in to the linked. The linked account attribute information acquisition unit 13 has an access right to the linked site IdP 20, and acquires the item of linked account attribute information from the linked site IdP 20 in a case where there is a user attempting to log in to the own site. The access right to the linked site IdP 20 is set, for example, according to a contract or the like for using the linked account for logging in to the own site. The linked account attribute information acquisition unit 13 is an example of an attribute information acquisition unit.

The attribute information comparison unit 14 compares the item of the acquired attribute information of the linked account with the item of the attribute information of the own site account. The attribute information comparison unit 14 extracts a deficient item in attribute information of each linked account. The deficient item is an item not included in attribute information of the linked account among items of attribute information necessary for obtaining an account for the own site. The attribute information comparison unit 14 is an example of a comparison unit.

The screen generation unit 15 generates a login screen for performing an operation to log in to the connection target site which is the own site. On the login screen, an input field for inputting an account for the own site is displayed. On the login screen, a linked site for which an account can be used is displayed as display indicating an account of another site that can be used to log in. Further, on the login screen, an item of attribute information of the linked account acquired by the linked account attribute information acquisition unit 13, a result of comparison by the attribute information comparison unit 14, information indicating a usage policy of the attribute information at the linked site, and the like are displayed. The usage policy of the attribute information defines a usage method and a disclosure range of the attribute information at the linked site from a viewpoint of personal information protection and the like. The login screen generated by the screen generation unit 15 is sent to the terminal device 30 and displayed on display means of the terminal device 30. Accordingly, the login screen generated by the screen generation unit 15 and the screen generation unit 15 is an example of a presentation unit. Details of the login screen will be described later.

The login control unit 16 receives a login operation performed on the terminal device 30 using a login screen, and controls login to the connection target site which is the own site. In a case where a login operation using a linked account is performed, the login control unit 16 acquires attribute information of the user from the linked site IdP 20, and registers the attribute information as attribute information related to the account of the user in the own site. Further, the login control unit 16 acquires information that can be acquired regardless of a user's input among information to be registered in the deficient item obtained as a comparison result by the attribute information comparison unit 14. Specifically, for example, in a case where the terminal device 30 holds information such as a user's name, date of birth, gender, and the like as user information, the login control unit 16 may acquire, from the terminal device 30, information corresponding to the deficient item among user information. In an external server (such as a database server) to which the system server 10 can connect in relation to the service of the connection target site, in a case where information correlated with the terminal device 30 such as attribute information of the user specified from the ID information of the terminal device 30 is held, the login control unit 16 may acquire information corresponding to the deficient item from the external server. Examples of the information correlated with such a terminal device 30 include so-called contact information for the user. Further, in a case where a browser of the terminal device 30 holds information of the user, the login control unit 16 may acquire the information corresponding to the deficient item from the browser. In a case where the user accesses the linked site from the terminal device 30 using the browser, the linked account and attribute information used for the access may be stored in the browser. In this case, the login control unit 16 can acquire the attribute information of the user from the browser. In a case where the login control unit 16 can obtain the information corresponding to the deficient item as described above, the login control unit 16 registers this information as attribute information related to the account of the user at the own site. The login control unit 16 is an example of an acquisition unit and an example of a registration unit.

In response to the acquisition request from the terminal device 30, the login control unit 16 acquires, from the linked site, information indicating the usage policy of the attribute information associated with the linked account. In the login screen displayed on the display means of the terminal device 30, the login control unit 16 can receive an acquisition request of information on the usage policy before the login operation is performed. The acquired information on the usage policy is passed from the login control unit 16 to the screen generation unit 15, and is displayed on the login screen by the screen generation unit 15. The login control unit 16 is an example of a usage policy information acquisition unit.

In a case where the user logs in using a linked account, the connection history information holding unit 17 holds connection history information of login using the linked account. The connection history information is acquired by, for example, the login control unit 16 at the time of login. The connection history information includes, for example, ID information of the terminal device 30, ID information of the user, the used linked account, information of the linked site, and the like. The connection history information holding unit 17 is an example of connection history information holding means.

The system server 10 having the functions described above may be configured as a single server machine, or may be configured as a system in which the functions are distributed to multiple servers. In any case, the server includes a central processing unit (CPU) which is operation means, and a main storage device (main memory) and an external storage unit which are storage means. The CPU reads a program stored in the external storage device into the main storage device and executes the program. For example, a random access memory (RAM) is used as the main storage device. For example, a magnetic disk device or a solid state drive (SSD) is used as the external storage device. The CPU executes a program to thereby realize respective functions, such as the attribute information management unit 12, the linked account attribute information acquisition unit 13, the attribute information comparison unit 14, the screen generation unit 15, and the login control unit 16, and the like, in the system server 10 described above.

Functional Configuration of Terminal Device

FIG. 3 is a diagram illustrating a functional configuration of the terminal device 30. The user uses the terminal device 30 to connect to the connection target site provided by the system server 10. As the terminal device 30, for example, a personal computer, a smartphone, or another information processing device is used. The terminal device 30 includes a communication unit 31, a display unit 32, an input receiving unit 33, and a control unit 34.

The communication unit 31 is a network interface for exchanging data with the system server 10 through the network. Connection means of the network is not particularly limited, and the communication channel may be a wired communication channel or wireless communication channel.

The display unit 32 displays various screens such as an information screen for notifying a user of information and an operation screen for receiving an operation by the user. The display unit 32 displays a login screen acquired from the system server 10 in order to log in to the connection target site. The display unit 32 is an example of an operation screen display unit. The display unit 32 is configured by, for example, a liquid crystal display.

As described above, on the login screen, the linked site as a display illustrating the account of the other site available for logging in, the item and the deficient lack item of the attribute information of the linked account, and information indicating the usage policy of the attribute information at the linked site and the like are displayed. Accordingly, the login screen displayed on the display unit 32 and the display unit 32 is an example of an account display unit, an attribute information display unit, and a usage policy display unit.

The input receiving unit 33 receives an input operation by the user on the operation screen displayed on the display unit 32 such as a login screen. The input receiving unit 33 is configured by, for example, a touch sensor that outputs a control signal according to a position touched or pressed by a finger. An interface device is configured by a touch panel in the touch sensor and the liquid crystal display of the display unit 32 are combined and a control unit 34 described later that controls display of the display unit 32. The input receiving unit 33 is an example of a reception unit.

The control unit 34 controls various operations of the terminal device 30. The control unit 34 includes, for example, a CPU, which is operation means, and a main memory device and an external memory, which are storage means. The CPU reads a program stored in the external storage device into the main storage device and executes the program. For example, a RAM is used as the main storage device. For example, a magnetic disk drive or an SSD is used as the external storage device. Each function of the terminal device 30 is realized by the CPU executing a program.

Operation Of System Server

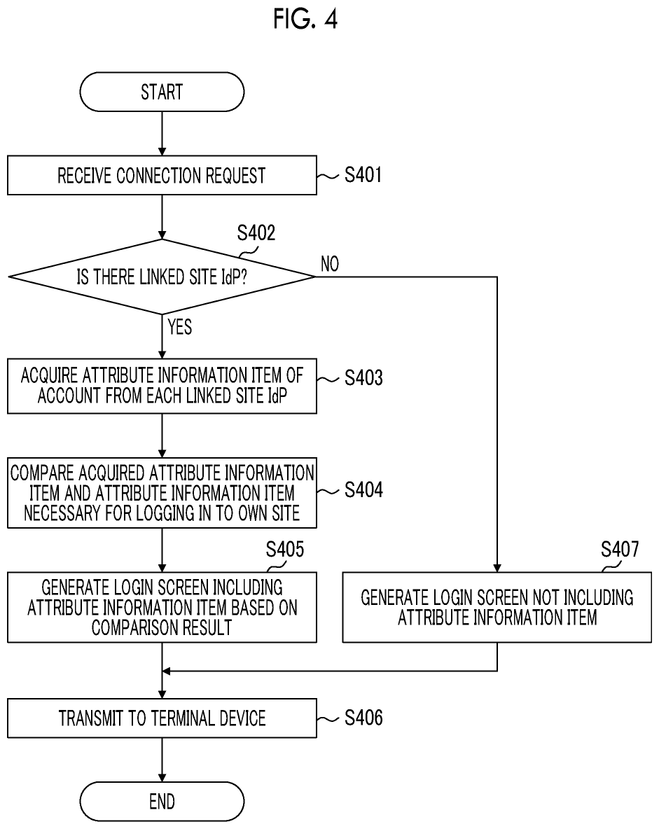

FIG. 4 is a flowchart illustrating the operation of the system server 10 at the time of login to the connection target server. In a case where a connection request from the terminal device 30 is received by the communication unit 11 of the system server 10 (S401), in a case where it is determined that there is a linked site IdP 20 (YES in S402), the linked account attribute information acquisition unit 13 acquires the attribute information item of the linked account from each linked site IdP 20 (S403). Next, the attribute information comparison unit 14 compares the attribute information item acquired by the linked account attribute information acquisition unit 13 with attribute information item necessary for logging in to the own site (S404). Then, the screen generation unit 15 generates a login screen including the attribute information item based on the comparison result of the attribute information comparison unit 14 (S405). The generated login screen is transmitted to the terminal device 30 by the communication unit 11 (S406).

On the other hand, in a case where it is determined that there is no linked site IdP 20 (NO in S402), acquisition of the attribute information item by the login control unit 16 is not performed, and the screen generation unit 15 generates a login screen not including the attribute information item (S407). The generated login screen is transmitted to the terminal device 30 by the communication unit 11 (S406).

In this operation example, in a case where there is a linked site IdP 20, a login screen including the attribute information item is voluntarily generated. In contrast, in a case where the display request for the attribute information item is received, the attribute information item may be displayed on the login screen, by initially generating a login screen not including the attribute information item and transmitting the login screen to the terminal device 30 and performing a predetermined operation different from the connection operation in the terminal device 30.

The terminal device 30 causes the display unit 32 to display the received login screen. The user performs a login operation based on the displayed login screen. In this case, in a case of logging in with the account for own site, the user inputs the own site account and issues a login instruction. In response to the login instruction, the login control unit 16 of the system server 10 executes a login process using the account for own site.

In a case where logging in using a linked account, display (display indicating the linked account) of the linked site on the login screen is selected and the login instruction is issued. In a case where the linked account is selected, when there is a deficient item, the screen generation unit 15 generates an input screen of the deficient item under the control of the login control unit 16 of the system server 10 and sends the input screen to the terminal device 30. The user inputs information on the deficient item in accordance with the instruction on the input screen, and transmits the information to the system server 10. In a case where the deficient item is complemented, the login control unit 16 executes the login process using the selected linked account.

Example Of Configuration Of Login Screen

Next, a configuration of the login screen will be described. In this exemplary embodiment, before the login operation is performed, information of a linked account that can be used for logging in to the connection target site is displayed on the login screen displayed on the display unit 32 of the terminal device 30. The user can refer to the information of this linked account and select the linked account used for logging in to the connection target site.

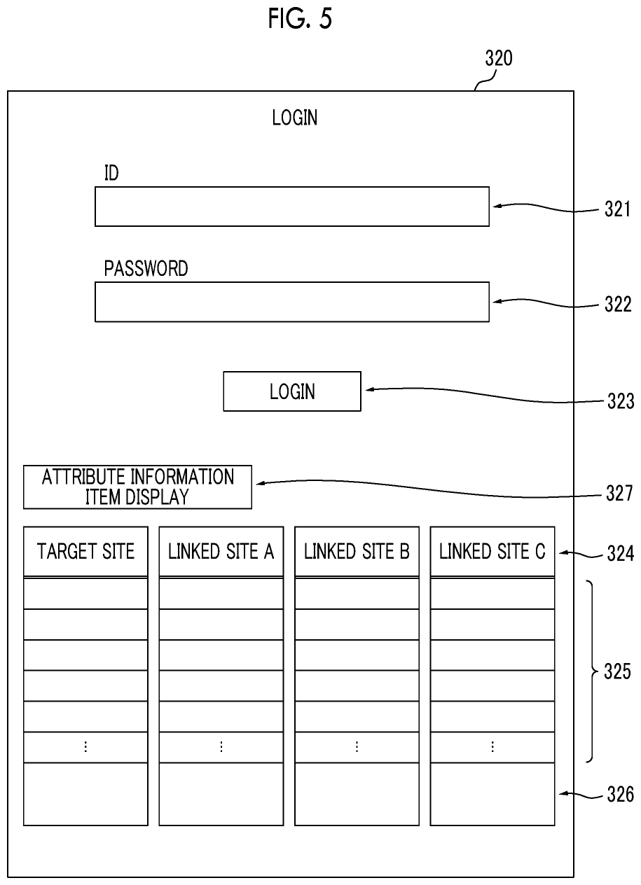

FIG. 5 is a view illustrating an example of the configuration of the login screen. In a login screen 320 illustrated in FIG. 5, an ID input field 321, a password input field 322, a login button 323, a linked site display portion 324, an attribute information display portion 325, a usage policy display portion 326, and information display button 327 are provided. The ID input field 321 is a text box (input field) for inputting an ID (identification information) for specifying the account for own site. The password input field 322 is a text box for inputting a password for authentication. The login button 323 is a button object for transmitting a request for execution of login to the connection target site to the system server 10. In a case where the user inputs an ID in the ID input field 321, inputs a password in the password input field 322, and performs a selection operation (for example, a mouse click) on the login button 323, the terminal device 30 sends a request for execution of login by the account for the own site, together with the input ID and password, to the system server 10. The login control unit 16 of the system server 10 performs user authentication using the received ID and password, and executes the login process.

On the linked site display portion 324, an image of a linked site in which a linked account that can be used for logging in to the connection target site is set is displayed. That is, the image of each linked site is a display illustrating the linked account at the linked site. The image of the linked site is, for example, an icon. The image of the linked site displayed on the linked site display portion 324 may serve also as the login button. In this case, in a case where the user selects and operates an image (login button) of one linked site, a request for execution of login by the linked account of the selected linked site is transmitted from the terminal device 30 to the system server 10. The login control unit 16 of the system server 10 acquires the selected linked account in response to the received login execution request, and executes the login process . The linked account is acquired, for example, from the selected linked site or the linked site IdP 20 of the linked account.

On the attribute information display portion 325 display related to an attribute information item associated with the linkage account of the linkage site is performed, for each of the linked sites displayed at the linked site display portion 324. Display related to the attribute information item includes a case where the item itself of the attribute information of each linked account is displayed and a case where the deficient item in each linked account is displayed. Specific display contents will be described later. On the usage policy display portion 326, the usage policy of the attribute information in the linked site is displayed for each linked site displayed in the linked site display portion 324.

The information display button 327 is a button object for performing display regarding an attribute information item on the attribute information display portion 325. That is, in the login screen 320, initially, although the image of the linked site is displayed on the linked site display portion 324, the attribute information item is not displayed on the attribute information display portion 325. Then, in a case where the information display button 327 is operated, a display request for the attribute information item is transmitted from the terminal device 30 to the system server 10, and in response to this display request, the attribute information item is displayed on the attribute information display portion 325. The same applies to display of the usage policy in the usage policy display portion 326, and the attribute information item is displayed according to the operation of the information display button 327.

Display Example Of Attribute Information Item and Usage Policy

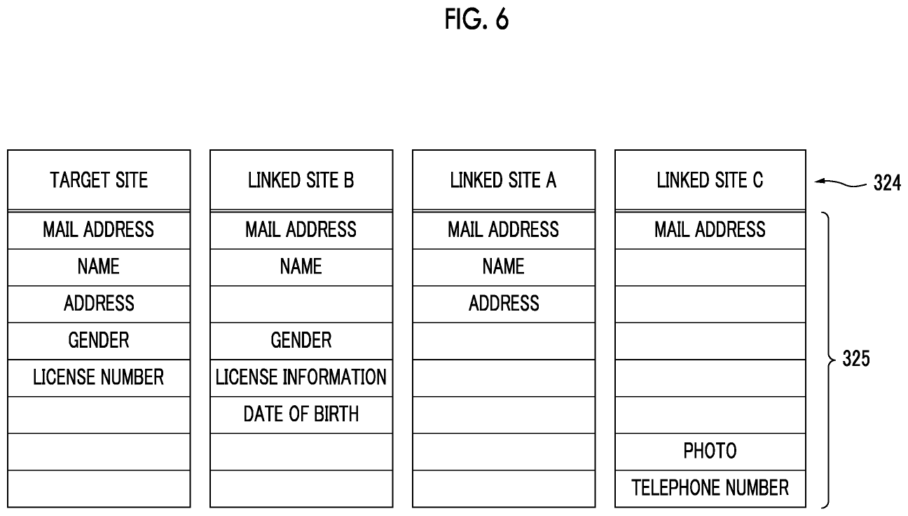

FIG. 6 is a view illustrating a display example of attribute information items on the login screen. In the display example illustrated in FIG. 6, the image of the own site (described as “target site” in the figure) is displayed together with the linked site, and the attribute information items are displayed below each image. The attribute information items of accounts (the own site account and respective linked accounts) are displayed in such a way that the same items are arranged side by side and contrasted.

In the display example illustrated in FIG. 6, an image and attribute information item of the own site are displayed at the left end of the attribute information display portion 325. Then, the images and attribute information items of respective linked sites are arranged at positions closer to the image and attribute information items of the own site in descending order of the number of the items common to the attribute information items of the account for own site. In other words, the images of the respective linked site are displayed by being arranged side by side at the linked site display portion 324 in order from the item having the most common items to the attribute information items of the account for the own site, and the attribute information items of respective linked accounts are displayed following the sequence of the images of the corresponding linked sites.

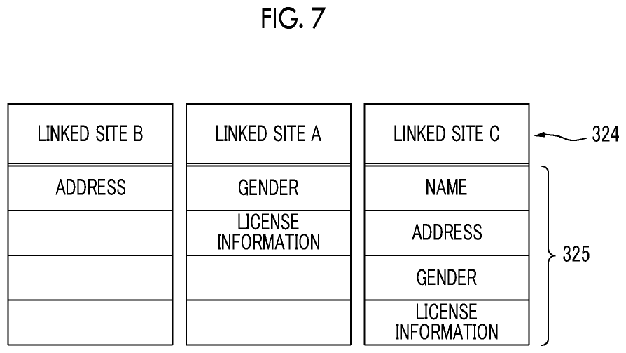

FIG. 7 is a view illustrating another display example of the attribute information item on the login screen. In the display example illustrated in FIG. 7, the image of the own site and the attribute information items are not displayed. Regarding each linked site, the deficient items (items not included in the attribute information of the linked account among the items of the attribute information of the account for own site) in the attribute information of the linked account itself rather than the attribute information items of the corresponding linked account itself is displayed.

In the display example illustrated in FIG. 7, the images of the respective linked sites and the deficient items in the respective linked accounts corresponding to the respective linked sites are arranged, from the left end of the attribute information display portion 325 to the right, in order from the item having the smallest number of deficient items. In other words, the images of the respective linked sites are displayed by being arranged side by side in order from the image having the smallest number of deficient items at the linked site display portion 324, and the deficient items in the respective linked accounts are displayed following the sequence of the images of the corresponding linked sites.

Furthermore, as described above, the display order of the images and deficient items of the respective linked sites are simply determined based on the number of the deficient items, and the images and deficient items of the respective linked sites maybe determined according to the length of time needed for input. The length of time needed for input can be analogized based on, for example, the number of operations needed for input. As a specific example, it is considered that the number of operations increases and the time needed for the input is long in the order of a telephone number where it is necessary to input numbers and an address and name where it is necessary to further input text than attribute information that can be selected by a radio button. Accordingly, it is conceivable to determine the display order of the images and the deficient items of the linked sites in the order of the linked site whose deficient item is only gender, the linked site whose telephone number is included in the deficient items, and the linked site whose address and name are included in the deficient items.

In a case where it is possible to specify a linked account possessed by the user, the image and the attribute information item (or the deficient item) of the linked site may be displayed only for the linked account. As an example, as described above, in a case where acquiring attribute information of the user stored in the browser and complementing a deficient item, it is conceivable to display the image and attribute information item (or the deficient item) of the linked site regarding the linked account whose information is held in the browser.

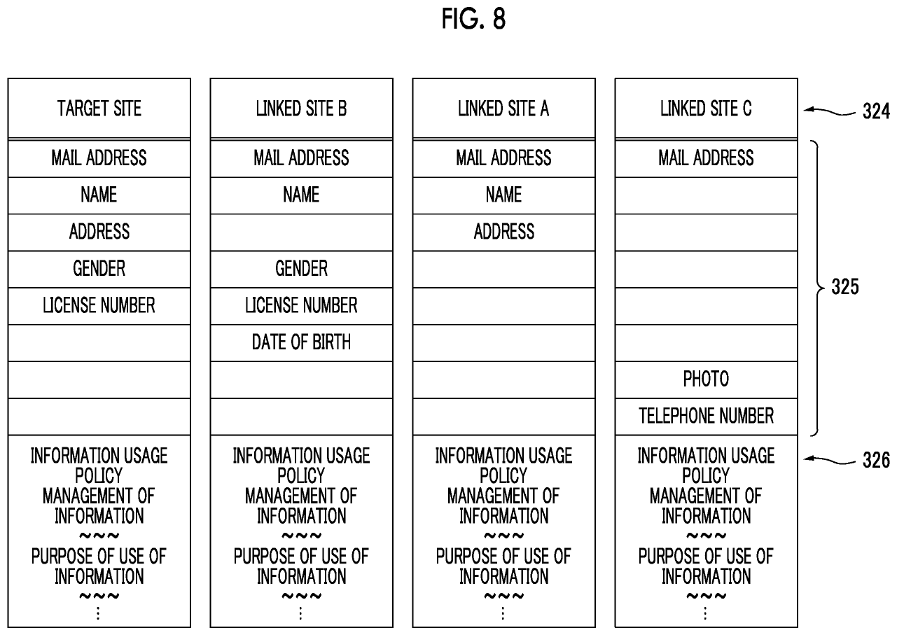

FIG. 8 is a view illustrating a display example of attribute information items and usage policies in the login screen. In the display example illustrated in FIG. 8, display of the attribute information display portion 325 is the same as the display example illustrated in FIG. 6. In the display example illustrated in FIG. 8, the usage policy of the attribute information in each linked site is displayed by being corresponded to the position of the image of the linked site at the linked site display portion 324, on the usage policy display portion 326 positioned below the attribute information display portion 325.

In the display example of the login screen 320 described with reference to FIGS. 5 to 8, the attribute information item and the like are displayed without distinguishing all the linked sites. In contrast, based on the connection history information held in the connection history information holding unit 17, the screen generation unit 15 may specify a linked account having a record of use for logging in to the connection target site, and may display information such as the attribute information item on the login screen 320 regarding the specified linked account.

In the example described above, on the login screen 320, the attribute information item is not displayed initially on the attribute information display portion 325, but is displayed after the information display button 327 is operated. In contrast, the information display button 327 may not be provided, and the attribute information display portion 325 may initially display the attribute information item on the login screen 320. The same applies to display of the usage policy in the usage policy display portion 326.

### MODIFICATION EXAMPLE

In the system configuration illustrated in FIG. 1, it is assumed that the connection target site itself permits login using the linked account. In contrast, a configuration in which a linked account is logged in by a relay server provided separately from the connection target site may be considered. The relay server relays communication between the system server 10, which is a connection target site, and the terminal device 30, edits a login screen sent from the system server 10 to the terminal device 30, and presents information on a linked account.

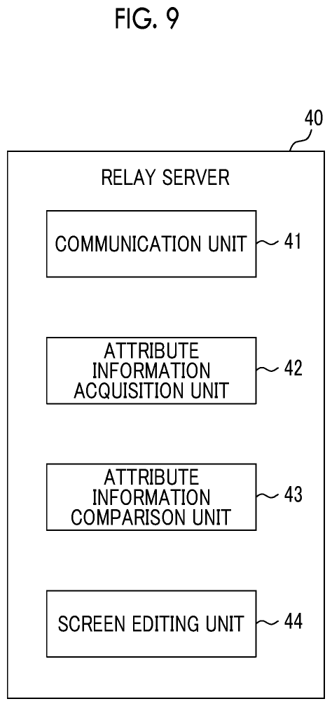

FIG. 9 is a diagram illustrating a configuration of a server (relay server) used as a relay site. A relay server 40 illustrated in FIG. 9 is provided separately from the connection target site, unlike the system server 10 illustrated in FIGS. 1 and 2. Then, the relay server 40 connects to the system server 10, the linked site IdP 20, and the terminal device 30 illustrated in FIG. 1 through the network. Even in the configuration using the relay server 40, the connection target site configured by the system server 10 permits login by the linked account. However, in this system configuration, the relay server 40 performs acquisition and presentation of information on an account for logging in to the linked site, not the system server 10.

As illustrated in FIG. 9, the relay server 40 includes a communication unit 41, an attribute information acquisition unit 42, an attribute information comparison unit 43, and a screen editing unit 44. The communication unit 41 is a network interface for exchanging data with the system server 10, the linked site IdP 20, and the terminal device 30 through a network. The connection means of the network is not particularly limited, and the communication channel may be a wired communication channel or a wireless communication channel.

The attribute information acquisition unit 42 acquires an account (hereinafter, referred to as a connection target site account) for logging in to the connection target site and items of attribute information associated with the linked account for logging in to the linked site. The attribute information acquisition unit 42 has an access right to the IdP (not illustrated) of the connection target site and the linked site IdP 20.

The attribute information comparison unit 43 compares the acquired item of the attribute information of the account for connection target site with the item of the attribute information of the linked account. Then, the attribute information comparison unit 43 extracts a deficient item for the item of the attribute information of the account for connection target site, regarding the attribute information of each linked account.

The screen editing unit 44 edits a login screen acquired from the connection target site. The login screen acquired from the connection target site is provided with an input field for inputting the account for connection target site, and a display of linked sites where the account can be used for connection to the connection target site. The screen editing unit 44 passes information of the linked site indicated on the login screen to the attribute information acquisition unit 42, and causes the attribute information acquisition unit 42 to acquire the item of the attribute information from the linked site IdP 20. Then, the screen editing unit 44 adds the item of the attribute information acquired by the attribute information acquisition unit 42 to the login screen in association with the linked site. The screen editing unit 44 may cause the attribute information acquisition unit 42 to acquire usage policy information of each linked site together with the item of attribute information, and add the usage policy to the login screen together with the item of attribute information.

As described above, the item of the attribute information and the usage policy are added to the login screen acquired from the connection target site. With this, the login screen acquired from the connection target site is edited to the same screen as the login screen 320 described with reference to FIGS. 5 to 8, and is sent to the terminal device 30.

Although the exemplary embodiments of the invention have been described above, the technical scope of the present disclosure is not limited to the embodiments described above. Various alternatives and modifications without departing from the scope of the technical idea of the present disclosure are included in the present disclosure.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
an attribute information acquisition unit that acquires attribute information associated with accounts to other sites available for connection to a connection target site; and
a presentation unit that presents, to a user, attribute information that needs to be input in a case of using the accounts to the other sites for the connection to the connection target site before the connection to the connection target site is performed.

2. The information processing apparatus according to claim 1,
wherein the presentation unit presents attribute information needed for obtaining an account to the connection target site and attribute information associated with the accounts of the other sites by contrasting items for classifying the attribute information.

3. The information processing apparatus according to claim 2,
wherein the presentation unit presents the attribute information associated with the accounts of the other sites in descending order of the number of the items common to the attribute information needed for obtaining the account to the connection target site.

4. The information processing apparatus according to claim 1,
wherein the presentation unit presents only the account owned by the user among the accounts of the other sites.

5. The information processing apparatus according to claim 2,
wherein the presentation unit presents only the account owned by the user among the accounts of the other sites.

6. The information processing apparatus according to claim 1, further comprising:
a comparison unit that compares the attribute information associated with the accounts to the other sites with the attribute information needed for obtaining the account to the connection target site,
wherein the presentation unit presents deficient items which are items not included in the attribute information associated with the accounts of the other sites among items of the attribute information needed for obtaining the account to the connection target site, based on the comparison result by the comparison unit.

7. The information processing apparatus according to claim 6,
wherein the presentation unit presents the deficient items in ascending order of the number of operations needed for input, among the deficient items.

8. The information processing apparatus according to claim 6,
wherein the presentation unit presents the deficient items in ascending order of the number of the items.

9. The information processing apparatus according to claim 6, further comprising:
an acquisition unit that acquires information registered in the deficient item; and
a registration unit that registers the information acquired by the acquisition unit in the deficient item.

10. The information processing apparatus according to claim 1, further comprising:
a connection history holding unit that holds a connection history to the other sites,
wherein the presentation unit presents attribute information associated with the accounts to the other sites with usage records based on the connection history.

11. The information processing apparatus according to claim 1, further comprising:
a usage policy information acquisition unit that acquires information indicating a usage policy of the attribute information associated with accounts from the other sites,
wherein the presentation unit presents information indicating the usage policy of the attribute information acquired by the usage policy information acquisition unit, together with the attribute information or separately from the attribute information.

12. An information processing apparatus comprising:
a reception unit that receives an operation by a user;
an operation screen display unit that displays an operation screen for receiving a connection operation for connection to a connection target site by the reception unit;
an account display unit that performs display indicating accounts of other sites available for connection to the connection target site; and
an attribute information display unit, in a case where a predetermined operation different from the connection operation is received by the reception unit, that performs display regarding attribute information that needs to be input in a case of connecting to the connection target site using the accounts of the other sites.

13. The information processing apparatus according to claim 12,
wherein the attribute information display unit displays attribute information needed for obtaining an account to the connection target site and attribute information associated with the accounts of the other sites by arranging the same items among items for classifying the attribute information side by side.

14. The information processing apparatus according to claim 13,
wherein the account display unit performs display indicating the accounts by arranging the items side by side in descending order of the number of the items common to the attribute information needed for obtaining the account to the connection target site, and
the attribute information display unit displays the attribute information following a sequence of displays indicating the accounts by the account display unit.

15. The information processing apparatus according to claim 12,
wherein the attribute information display unit displays only the deficient items which are items not included in the attribute information associated with the accounts of the other sites among items of the attribute information needed for obtaining the account to the connection target site.

16. The information processing apparatus according to claim 15,
wherein the account display unit performs display indicating the accounts by arranging deficient items side by side in ascending order of the number of operations needed for input, among the deficient items, and
the attribute information display unit displays the attribute information following a sequence of displays indicating the accounts by the account display unit.

17. The information processing apparatus according to claim 15,
wherein the account display unit performs display indicating the accounts by arranging the deficient items side by side in ascending order of the number of the items, and
the attribute information display unit displays the attribute information following a sequence of displays indicating the accounts by the account display unit.

18. The information processing apparatus according to claim 12, further comprising:
a usage policy display unit that displays information indicating a usage policy of attribute information associated with accounts in the other sites.

19. A non-transitory computer readable medium storing a program causing a computer to implement:
a function of acquiring attribute information associated with accounts to other sites available for connection to a connection target site; and
a function of presenting, to a user, attribute information that needs to be input in a case of using the accounts to the other sites for the connection to the connection target site before the connection to the connection target site is performed.

20. A non-transitory computer readable medium storing a program causing a computer to implement:
a function of displaying an operation screen for receiving a connection operation for connecting to a connection target site;
a function of displaying accounts of other sites available for connection to the connection target site; and
a function of performing display regarding attribute information that needs to be input in a case of connecting to the connection target site using an account of the other site, in a case where a predetermined operation different from the connection operation is received.
